(19) United States
(12) Patent Application Publication
(10) Pub. No.: US 2026/0356361 A1
(43) Pub. Date: Nov. 12, 2026

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Toyota-shi (JP); DENSO CORPORATION, Kariya-city (JP)

(72) Inventors: Hirotada OTAKE, Susono-shi (JP); Hideki KAMATANI, Toyota-shi (JP); Hiroki TERASHITA, Susono-shi (JP)

(73) Assignees: TOYOTA JIDOSHA KABUSHIKI KAISHA, Toyota-shi (JP); DENSO CORPORATION, Kariya-city (JP)

(21) Appl. No.: 19/561,898

(22) Filed: Mar. 10, 2026

(30) Foreign Application Priority Data
Mar. 12, 2025 (JP) 2025-039293

(51) Int. Cl. B60W 30/16; B60W 30/18; B60W 60/00

(52) U.S. Cl. CPC B60W 30/16; B60W 30/18072; B60W 60/001; B60W 2554/4041; B60W 2720/10; B60W 2754/30

(57) ABSTRACT

A vehicle driving assistance apparatus executes intermittent vehicle speed and inter-vehicle distance controls. The intermittent vehicle speed control drives the host vehicle such that a host vehicle's travel speed is maintained within a predetermined vehicle speed range when a preceding vehicle does not exist. The intermittent inter-vehicle distance control drives the host vehicle such that an inter-vehicle distance between the host and preceding vehicles is maintained within a predetermined distance range when the preceding vehicle exists. When a driving assistance level is set to a first level, the apparatus sets the predetermined ranges to narrower ranges as compared with when the driving assistance level is set to a second level higher than the first level. The apparatus does not execute the intermittent inter-vehicle distance control when execution of the intermittent inter-vehicle distance control is requested and the driving assistance level is set to a predetermined level or less.

### CROSS-REFERENCE TO RELATED APPLICATIONS

This application claims priority to Japanese patent application No. JP 2025-039293 filed on Mar. 12, 2025, the content of which is hereby incorporated by reference in its entirety.

### BACKGROUND

### Field

The present invention relates to a vehicle driving assistance apparatus, a vehicle driving assistance method, and a computer-readable non-transitory storage medium storing a vehicle driving assistance program.

### Description of the Related Art

There is known a vehicle driving assistance apparatus that executes, as an intermittent travel control, an intermittent inter-vehicle distance control of driving a host vehicle by autonomously and alternately repeating powering of the host vehicle and coasting of the host vehicle such that an inter-vehicle distance between the host vehicle and a preceding vehicle is maintained within a predetermined distance range.

Also, there is known a vehicle driving assistance apparatus that stops the intermittent inter-vehicle distance control and executes a constant inter-vehicle distance control as a constant travel control when the host vehicle is close to the preceding vehicle and is approaching the preceding vehicle relatively fast (for example, see Japanese Unexamined Patent Application Publication No. 2022-95320). The constant inter-vehicle distance control here is a control of driving the host vehicle by autonomously performing acceleration and deceleration of the host vehicle such that the inter-vehicle distance between the host vehicle and the preceding vehicle is maintained at a predetermined inter-vehicle distance. Thus, in the conventional vehicle driving assistance apparatus, execution of the intermittent inter-vehicle distance control is prohibited depending on a travel state of the host vehicle.

On the other hand, there is known a vehicle driving assistance apparatus in which a driver of the host vehicle is able to set a driving assistance level for the intermittent inter-vehicle distance control. Here, when a weak assistance level of a relatively low driving assistance level is selected, the driver does not desire that a travel speed of the host vehicle changes greatly. However, when the intermittent inter-vehicle distance control is executed while the weak assistance level is selected, depending on a travel speed of the preceding vehicle, the travel speed of the host vehicle may greatly change.

### SUMMARY

An object of the present invention is to provide a vehicle driving assistance apparatus, a vehicle driving assistance method, and a computer-readable non-transitory storage medium storing a vehicle driving assistance program that are capable of executing the driving assistance control at a driving assistance level in accordance with an intention of an operator of the host vehicle.

A vehicle driving assistance apparatus according to the present invention includes an electronic control unit that executes an intermittent travel control of autonomously driving a host vehicle as a driving assistance control. The intermittent travel control includes an intermittent vehicle speed control and an intermittent inter-vehicle distance control. The intermittent vehicle speed control is a control of driving the host vehicle by autonomously and alternately repeating a powering control of causing the host vehicle to travel by a driving force and a coasting control of causing the host vehicle to coast such that a travel speed of the host vehicle is maintained within a predetermined vehicle speed range when a preceding vehicle does not exist. The intermittent inter-vehicle distance control is a control of driving the host vehicle by autonomously and alternately repeating the powering control and the coasting control such that an inter-vehicle distance between the host vehicle and the preceding vehicle is maintained within a predetermined distance range when the preceding vehicle exists. A driving assistance level for the host vehicle by the intermittent travel control being set by an operator of the host vehicle. The electronic control unit is configured to, when the driving assistance level is set to a first level, set the predetermined vehicle speed range and the predetermined distance range to narrower ranges as compared with when the driving assistance level is set to a second level higher than the first level. Further, the electronic control unit is configured to not execute the intermittent inter-vehicle distance control when execution of the intermittent inter-vehicle distance control is requested and the driving assistance level is set to a predetermined level or less.

When the operator of the host vehicle sets the driving assistance level to a low level, the operator desires that a travel speed of the host vehicle does not greatly change. However, during execution of the intermittent inter-vehicle distance control, depending on a travel speed of the preceding vehicle, the travel speed of the host vehicle may greatly change. Therefore, even when the operator sets the driving assistance level to a low level, when the intermittent inter-vehicle distance control is executed, the travel speed of the host vehicle may greatly change.

According to the vehicle driving assistance apparatus of the present invention, when the driving assistance level is set to a low level, the intermittent inter-vehicle distance control is not executed. Therefore, when the operator desires that the travel speed of the host vehicle does not greatly change, it is possible to suppress the travel speed of the host vehicle from greatly changing. Thus, it is possible to execute the driving assistance control at a driving assistance level in accordance with an intention of the operator of the host vehicle.

In the vehicle driving assistance apparatus according to an aspect of the present invention, the electronic control unit may be configured to not execute the intermittent inter-vehicle distance control when execution of the intermittent inter-vehicle distance control is requested and the driving assistance level is set to the predetermined level or less. Further, in this aspect, the electronic control unit may be configured to stop the intermittent inter-vehicle distance control when the driving assistance level is set to the predetermined level or less while the intermittent inter-vehicle distance control is executed.

According to the vehicle driving assistance apparatus of this aspect of the present invention, even when execution of the intermittent inter-vehicle distance control is requested, when the driving assistance level is set to the predetermined level or less, the intermittent inter-vehicle distance control is not executed. Further, when the driving assistance level is set to the predetermined level or less during execution of the intermittent inter-vehicle distance control, the intermittent inter-vehicle distance control is stopped. Therefore, it is possible to execute the driving assistance control at a driving assistance level in accordance with an intention of the operator of the host vehicle.

In the vehicle driving assistance apparatus according to another aspect of the present invention, the electronic control unit may be configured to execute a constant inter-vehicle distance control as the driving assistance control without executing the intermittent inter-vehicle distance control when execution of the intermittent inter-vehicle distance control is requested and the driving assistance level is set to the predetermined level or less. Further, in this aspect, the electronic control unit may be configured to stop the intermittent inter-vehicle distance control and execute the constant inter-vehicle distance control as the driving assistance control when the driving assistance level is set to the predetermined level or less while the intermittent inter-vehicle distance control is being executed. In this aspect, the constant inter-vehicle distance control is a control of driving the host vehicle by autonomously performing acceleration and deceleration of the host vehicle such that the inter-vehicle distance is maintained at a predetermined inter-vehicle distance when the preceding vehicle exists.

According to the vehicle driving assistance apparatus of this aspect of the present invention, when the intermittent inter-vehicle distance control is not executed, or when the intermittent inter-vehicle distance control is stopped, the constant inter-vehicle distance control is executed. Therefore, even when the intermittent inter-vehicle distance control is not executed, it is possible to continue autonomously driving the host vehicle.

Further, a vehicle driving assistance method according to the present invention is a method for executing an intermittent travel control of autonomously driving a host vehicle as a driving assistance control. The intermittent travel control includes an intermittent vehicle speed control and an intermittent inter-vehicle distance control. The intermittent vehicle speed control is a control of driving the host vehicle by autonomously and alternately repeating a powering control of causing the host vehicle to travel by a driving force and a coasting control of causing the host vehicle to coast such that a travel speed of the host vehicle is maintained within a predetermined vehicle speed range when a preceding vehicle does not exist. The intermittent inter-vehicle distance control is a control of driving the host vehicle by autonomously and alternately repeating the powering control and the coasting control such that an inter-vehicle distance between the host vehicle and the preceding vehicle is maintained within a predetermined distance range when the preceding vehicle exists. A driving assistance level for the host vehicle by the intermittent travel control is set by an operator of the host vehicle. The vehicle driving assistance method comprises a step of, when the driving assistance level is set to a first level, setting the predetermined vehicle speed range and the predetermined distance range to narrower ranges as compared with when the driving assistance level is set to a second level higher than the first level. The vehicle driving assistance method further comprises a step of not executing the intermittent inter-vehicle distance control when execution of the intermittent inter-vehicle distance control is requested and the driving assistance level is set to a predetermined level or less.

According to the vehicle driving assistance method of the present invention, for the same reasons as described above, it is possible to execute the driving assistance control at a driving assistance level in accordance with an intention of the operator of the host vehicle.

Furthermore, a computer-readable non-transitory storage medium according to the present invention stores a vehicle driving assistance program that executes an intermittent travel control of autonomously traveling a host vehicle as a driving assistance control. The intermittent travel control includes an intermittent vehicle speed control and an intermittent inter-vehicle distance control. The intermittent vehicle speed control is a control of driving the host vehicle by autonomously and alternately repeating a powering control of causing the host vehicle to travel by a driving force and a coasting control of causing the host vehicle to coast such that a travel speed of the host vehicle is maintained within a predetermined vehicle speed range when a preceding vehicle does not exist. The intermittent inter-vehicle distance control is a control of driving the host vehicle by autonomously and alternately repeating the powering control and the coasting control such that an inter-vehicle distance between the host vehicle and the preceding vehicle is maintained within a predetermined distance range when the preceding vehicle exists. A driving assistance level for the host vehicle by the intermittent travel control is set by an operator of the host vehicle. The vehicle driving assistance program is configured to, when the driving assistance level is set to a first level, set the predetermined vehicle speed range and the predetermined distance range to narrower ranges as compared with when the driving assistance level is set to a second level higher than the first level.

Further, the driving assistance program is configured to not execute the intermittent inter-vehicle distance control when execution of the intermittent inter-vehicle distance control is requested and the driving assistance level is set to a predetermined level or less.

According to the vehicle driving assistance program of the present invention, for the same reasons as described above, it is possible to execute the driving assistance control at a driving assistance level in accordance with an intention of the operator of the host vehicle.

Elements of the present invention are not limited to elements of embodiments and modified examples of the present invention described with reference to the drawings. The other objects, features and accompanied advantages of the present invention can be easily understood from the embodiments and the modified examples of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a situation where a preceding vehicle exists.

FIG. 3 is a flowchart showing a routine executed by the vehicle driving assistance apparatus according to the embodiment of the present invention.

### DETAILED DESCRIPTION

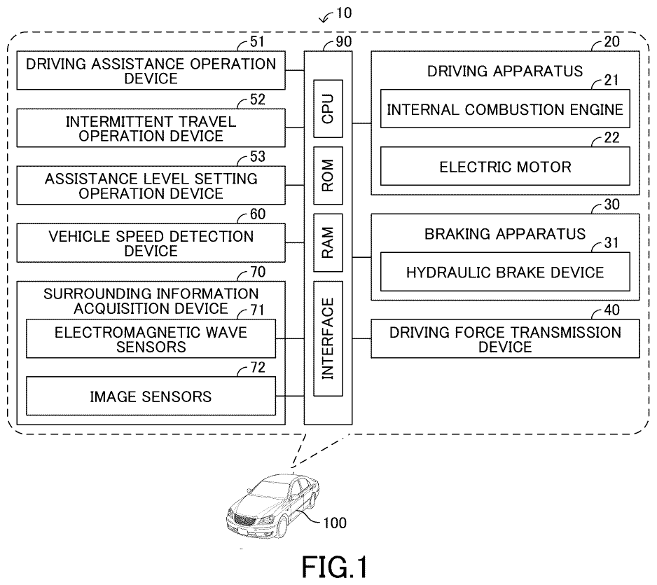

Hereinafter, a vehicle driving assistance apparatus, a vehicle driving assistance method, and a computer-readable non-transitory storage medium storing a vehicle driving assistance program according to an embodiment of the present invention will be described with reference to the drawings. As shown in FIG. 1, a vehicle driving assistance apparatus 10 according to the embodiment of the present invention is shown. The vehicle driving assistance apparatus 10 is mounted on a host vehicle 100. Hereinafter, the vehicle driving assistance apparatus 10 will be described with an example in which an operator or a user of the host vehicle 100 is a driver of the host vehicle 100 (that is, a person who boards the host vehicle 100 and drives the host vehicle 100). However, the operator or the user of the host vehicle 100 may be a remote operator of the host vehicle 100 (that is, a person who does not board the host vehicle 100 and remotely drives the host vehicle 100). It should be noted that, in the following description, the driver of the host vehicle 100 may be simply referred to as “the driver”.

As shown in FIG. 1, the vehicle driving assistance apparatus 10 includes an ECU (Electronic Control Unit) 90 as a control device. The ECU 90 includes a microcomputer as a main component. The microcomputer includes a CPU, a computer-readable non-transitory storage medium, and an interface. The storage medium includes a ROM, a RAM, and a nonvolatile memory. The CPU realizes various functions by executing instructions or programs or routines stored in the storage medium. In particular, in this example, the vehicle driving assistance apparatus 10 stores, in the storage medium, programs for realizing various controls executed by the vehicle driving assistance apparatus 10.

It should be noted that, in this example, the vehicle driving assistance apparatus 10 includes only one ECU 90; however, the vehicle driving assistance apparatus 10 may include a plurality of ECUs and be configured such that the functions of the vehicle driving assistance apparatus 10 described below are shared among the respective ECUs.

Also, the vehicle driving assistance apparatus 10 may be configured to update (upgrade) the programs stored in the storage medium by wireless communication (for example, Internet communication) with external devices.

Also, the vehicle driving assistance apparatus 10 can be applied not only to a vehicle that travels by manual driving by the operator but also to a vehicle that travels by automatic driving.

As shown in FIG. 1, the host vehicle 100 is equipped with a driving apparatus 20, a braking apparatus 30, and a driving force transmission device 40.

The driving apparatus 20 generates a driving force applied to the host vehicle 100 (in particular, driving wheels of the host vehicle 100). In this example, the driving apparatus 20 includes an internal combustion engine 21 and at least one electric motor 22. the driving apparatus 20 is electrically connected to the ECU 90. The vehicle driving assistance apparatus 10 controls the driving force applied to the host vehicle 100 by controlling operations of the driving apparatus 20 (that is, the internal combustion engine 21 and the electric motor 22).

The braking apparatus 30 applies a braking force to the host vehicle 100 (in particular, wheels of the host vehicle 100). In this example, the braking apparatus 30 includes a hydraulic brake device 31. The braking apparatus 30 is electrically connected to the ECU 90. The vehicle driving assistance apparatus 10 controls the braking force applied to the host vehicle 100 by controlling operations of the braking apparatus 30 (more specifically, operation of the hydraulic brake device 31).

The driving force transmission device 40 transmits the driving force output from the driving apparatus 20 to the driving wheels of the host vehicle 100. The driving force transmission device 40 is, for example, a transmission. The driving force transmission device 40 is electrically connected to the ECU 90.

The vehicle driving assistance apparatus 10 establishes a driving force transmission path by controlling operations of the driving force transmission device 40 such that the driving force output from the driving apparatus 20 is transmitted to the driving wheels of the host vehicle 100. The driving force transmission path is a path for transmitting the driving force from the driving apparatus 20 to the driving wheels of the host vehicle 100. On the other hand, the vehicle driving assistance apparatus 10 also interrupts the driving force transmission path by controlling operations of the driving force transmission device 40 such that the driving force is not transmitted from the driving apparatus 20 to the driving wheels of the host vehicle 100.

Further, the host vehicle 100 is equipped with a driving assistance operation device 51, an intermittent travel operation device 52, an assistance level setting operation device 53, a vehicle speed detection device 60, and a surrounding information acquisition device 70.

The driving assistance operation device 51 is operated by the driver. The driver requests execution of a driving assistance control or requests stopping thereof by operating the driving assistance operation device 51. The driving assistance operation device 51 is electrically connected to the ECU 90.

The vehicle driving assistance apparatus 10 determines that execution of the driving assistance control is requested when the driving assistance operation device 51 is operated while the driving assistance control is not executed. On the other hand, the vehicle driving assistance apparatus 10 determines that stopping of the driving assistance control is requested when the driving assistance operation device 51 is operated while the driving assistance control is being executed.

The intermittent travel operation device 52 is also operated by the driver. The driver requests execution of an intermittent travel control described later or requests stopping thereof by operating the intermittent travel operation device 52. The intermittent travel operation device 52 is electrically connected to the ECU 90.

When execution of the driving assistance control is requested but the intermittent travel control is not executed, and the intermittent travel operation device 52 is operated, the vehicle driving assistance apparatus 10 determines that execution of the intermittent travel control is requested. On the other hand, when the intermittent travel control is being executed and the intermittent travel operation device 52 is operated, the vehicle driving assistance apparatus 10 determines that stopping of the intermittent travel control is requested and that execution of a constant travel control described later is requested.

The assistance level setting operation device 53 is also operated by the driver. The driver sets a driving assistance level L by operating the assistance level setting operation device 53. In this example, three levels are prepared as the driving assistance level L: a strong assistance level Ls, a medium assistance level Lm, and a weak assistance level Lw. The assistance level setting operation device 53 is electrically connected to the ECU 90. The vehicle driving assistance apparatus 10 acquires the driving assistance level L set by an operation on the assistance level setting operation device 53. As described later, the vehicle driving assistance apparatus 10 changes control parameters of the intermittent travel control according to the set driving assistance level L.

Thus, in this example, the driving assistance level L for the host vehicle 100 by the intermittent travel control is set by the driver of the host vehicle 100.

The vehicle speed detection device 60 is used to detect a host vehicle speed V1. The host vehicle speed V1 is a travel speed of the host vehicle 100. The vehicle speed detection device 60 includes, for example, wheel speed sensors provided at respective wheels of the host vehicle 100. The vehicle speed detection device 60 is electrically connected to the ECU 90. The vehicle driving assistance apparatus 10 acquires the host vehicle speed V1 by the vehicle speed detection device 60.

The surrounding information acquisition device 70 is used to detect information surrounding the host vehicle 100. In this example, the surrounding information acquisition device 70 includes a plurality of electromagnetic wave sensors 71 and a plurality of image sensors 72.

The electromagnetic wave sensor 71 is electrically connected to the ECU 90. The electromagnetic wave sensor 71 is, for example, a radar sensor such as a millimeter wave radar. The vehicle driving assistance apparatus 10 acquires, as surrounding information IS, information on objects present around the host vehicle 100 (object information IO) by the electromagnetic wave sensors 71. In particular, the object information IO includes information on a preceding vehicle 200.

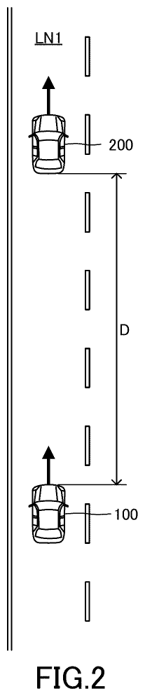

As shown in FIG. 2, the preceding vehicle 200 is another vehicle that travels in a host vehicle travel lane LN1 and exists ahead of the host vehicle 100 within a predetermined distance Dp. The host vehicle travel lane LN1 is a lane in which the host vehicle 100 is traveling.

The image sensor 72 is electrically connected to the ECU 90. The image sensor 72 is, for example, a camera sensor. The vehicle driving assistance apparatus 10 acquires, as surrounding information IS, image information IC on surroundings of the host vehicle 100 by the image sensors 72. In particular, the image information IC includes information on the preceding vehicle 200.

### Operation Of Vehicle Driving Assistance Apparatus

Next, the operation of the vehicle driving assistance apparatus 10 will be described.

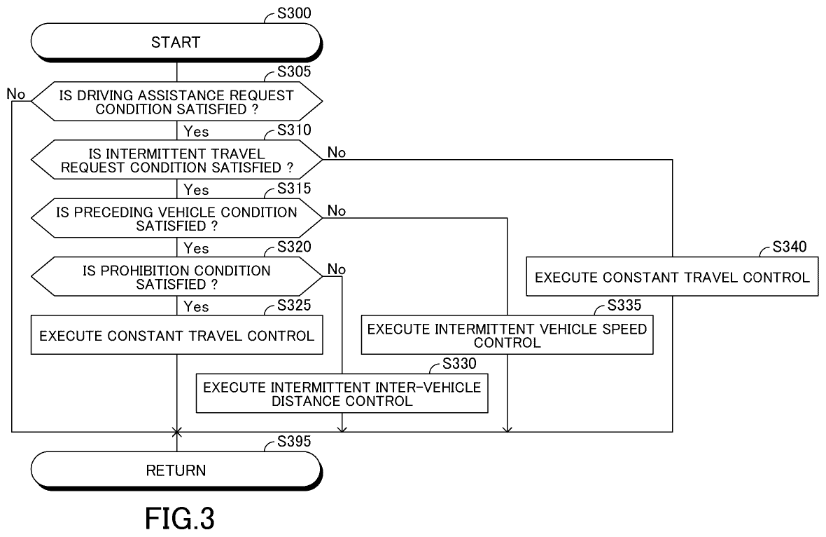

The vehicle driving assistance apparatus 10 executes the routine shown in FIG. 3 at predetermined time intervals, and, when predetermined conditions are satisfied, executes a driving assistance control. The driving assistance control is a control of autonomously driving the host vehicle 100. The driving assistance control includes a constant travel control and an intermittent travel control.

The constant travel control includes a constant vehicle speed control and a constant inter-vehicle distance control.

When the preceding vehicle 200 exists as shown in FIG. 2, the vehicle driving assistance apparatus 10 executes the constant inter-vehicle distance control as the constant travel control. On the other hand, when the preceding vehicle 200 does not exist, the vehicle driving assistance apparatus 10 executes the constant vehicle speed control as the constant travel control. The vehicle driving assistance apparatus 10 detects the preceding vehicle 200 based on the surrounding information IS.

The constant vehicle speed control is a control of autonomously driving the host vehicle 100 by controlling operations of the driving apparatus 20 and the braking apparatus 30 such that the host vehicle speed V1 is maintained at a set vehicle speed Vset. The set vehicle speed Vset is set by the driver.

Thus, the constant vehicle speed control is a control of driving the host vehicle 100 by autonomously accelerating and decelerating the host vehicle 100 such that the host vehicle speed V1 is maintained at a predetermined speed (that is, the set vehicle speed Vset) when the preceding vehicle 200 does not exist.

On the other hand, the constant inter-vehicle distance control is a control of autonomously driving the host vehicle 100 by controlling operations of the driving apparatus 20 and the braking apparatus 30 such that an inter-vehicle distance D is maintained at a set inter-vehicle distance Dset. The inter-vehicle distance D is a distance between the host vehicle 100 and the preceding vehicle 200. The vehicle driving assistance apparatus 10 acquires the inter-vehicle distance D based on the surrounding information IS. The set inter-vehicle distance Dset is set by the driver.

Thus, the constant inter-vehicle distance control is a control of driving the host vehicle 100 by autonomously accelerating and decelerating the host vehicle 100 such that the inter-vehicle distance D is maintained at a predetermined inter-vehicle distance (that is, the set inter-vehicle distance Dset) when the preceding vehicle 200 exists.

Further, the intermittent travel control includes an intermittent vehicle speed control and an intermittent inter-vehicle distance control.

The intermittent travel control includes a powering control and a coasting control. The intermittent travel control is a control of autonomously driving the host vehicle 100 by alternately switching between the powering control and the coasting control unless a predetermined condition described later is satisfied.

The powering control is a control of causing the host vehicle 100 to travel by the driving force. In particular, in this example, the powering control is a control of causing the host vehicle 100 to travel by the driving force such that the host vehicle 100 is accelerated. The vehicle driving assistance apparatus 10 causes the host vehicle 100 to travel by the driving force by applying the driving force from the driving apparatus 20 to the host vehicle 100 during execution of the powering control. It should be noted that an optimal powering control may be adopted as the powering control. The optimal powering control is a control of causing the host vehicle 100 to travel by the driving force by applying the driving force from the driving apparatus 20 to the host vehicle 100 while controlling operations of the driving apparatus 20 such that driving energy efficiency becomes highest. It should be noted that the driving energy efficiency is energy efficiency for generating the driving force by the driving apparatus 20.

The coasting control is a control of causing the host vehicle 100 to coast. The vehicle driving assistance apparatus 10 causes the host vehicle 100 to coast by stopping application of the driving force from the driving apparatus 20 to the host vehicle 100 during execution of the coasting control. In this example, the vehicle driving assistance apparatus 10 stops application of the driving force from the driving apparatus 20 to the host vehicle 100 by cutting off the driving-force transmission path during execution of the coasting control. As described above, the driving-force transmission path is a path for applying the driving force from the driving apparatus 20 to the host vehicle 100. The vehicle driving assistance apparatus 10 cuts off the driving-force transmission path by controlling operations of the driving force transmission device 40. It should be noted that, in this example, the operation of the internal combustion engine 21 is stopped during execution of the coasting control.

When the preceding vehicle 200 exists as shown in FIG. 2, the vehicle driving assistance apparatus 10 executes the intermittent inter-vehicle distance control as the intermittent travel control. On the other hand, when the preceding vehicle 200 does not exist, the vehicle driving assistance apparatus 10 executes the intermittent vehicle speed control as the intermittent travel control.

The intermittent vehicle speed control is a control of autonomously driving the host vehicle 100 by alternately repeating the powering control and the coasting control such that the host vehicle speed V1 is maintained at a speed within a target vehicle speed range RVtgt. Therefore, during execution of the intermittent vehicle speed control, the vehicle driving assistance apparatus 10 alternately switches between the powering control and the coasting control such that the host vehicle speed V1 is maintained within a predetermined range (that is, the target vehicle speed range RVtgt).

During execution of the intermittent vehicle speed control, when the host vehicle speed V1 increases due to execution of the powering control and reaches an upper limit vehicle speed Vmax, the vehicle driving assistance apparatus 10 ends the powering control and starts the coasting control. The upper limit vehicle speed Vmax is an upper limit value of the target vehicle speed range RVtgt. In this example, the set vehicle speed Vset is set as the upper limit vehicle speed Vmax (Vmax=Vset).

On the other hand, during execution of the intermittent vehicle speed control, when the host vehicle speed V1 decreases due to execution of the coasting control and reaches a lower limit vehicle speed Vmin, the vehicle driving assistance apparatus 10 ends the coasting control and starts the powering control. The lower limit vehicle speed Vmin is a lower limit value of the target vehicle speed range RVtgt. In this example, the lower limit vehicle speed Vmin is a value obtained by subtracting a target vehicle speed control width WVtgt from the set vehicle speed Vset (Vmin=Vset−WVtgt).

Thus, the intermittent vehicle speed control is a control of driving the host vehicle 100 by autonomously and alternately repeating the powering control and the coasting control such that the host vehicle speed V1 is maintained within a predetermined vehicle speed range (that is, the target vehicle speed range RVtgt) when the preceding vehicle 200 does not exist.

The intermittent inter-vehicle distance control is a control of autonomously driving the host vehicle 100 by autonomously and alternately repeating the powering control and the coasting control such that the inter-vehicle distance D is maintained at a distance within a target inter-vehicle distance range RDtgt. Therefore, during execution of the intermittent inter-vehicle distance control, the vehicle driving assistance apparatus 10 alternately switches between the powering control and the coasting control such that the inter-vehicle distance D is maintained within a predetermined range (that is, the target inter-vehicle distance range RDtgt).

During execution of the intermittent inter-vehicle distance control, when the inter-vehicle distance D becomes short due to execution of the powering control and reaches a lower limit inter-vehicle distance Dmin, the vehicle driving assistance apparatus 10 ends the powering control and starts the coasting control. The lower limit inter-vehicle distance Dmin is a lower limit value of the target inter-vehicle distance range RDtgt. In this example, the set inter-vehicle distance Dset is set as the lower limit inter-vehicle distance Dmin (Dmin=Dset).

On the other hand, during execution of the intermittent inter-vehicle distance control, when the inter-vehicle distance D becomes long due to execution of the coasting control and reaches an upper limit inter-vehicle distance Dmax, the vehicle driving assistance apparatus 10 ends the coasting control and starts the powering control. The upper limit inter-vehicle distance Dmax is an upper limit value of the target inter-vehicle distance range RDtgt. In this example, the upper limit inter-vehicle distance Dmax is a value obtained by adding a target inter-vehicle distance control width WDtgt to the lower limit inter-vehicle distance Dmin (Dmax=Dmin+WDtgt).

Thus, the intermittent inter-vehicle distance control is a control of driving the host vehicle 100 by autonomously and alternately repeating the powering control and the coasting control such that the inter-vehicle distance D is maintained within a predetermined distance range (that is, the target inter-vehicle distance range RDtgt) when the preceding vehicle 200 exists.

It should be noted that, during execution of the powering control, when the host vehicle speed V1 reaches the upper limit vehicle speed Vmax before the inter-vehicle distance D reaches the lower limit inter-vehicle distance Dmin, the vehicle driving assistance apparatus 10 stops the powering control, and executes an upper limit vehicle speed maintaining control of controlling acceleration and deceleration of the host vehicle 100 such that the host vehicle speed V1 is maintained at the upper limit vehicle speed Vmax.

Further, when the driver operates the assistance level setting operation device 53 to set the driving assistance level L to the strong assistance level Ls, the vehicle driving assistance apparatus 10 sets the target vehicle speed control width WVtgt and the target inter-vehicle distance control width WDtgt to an enlarged vehicle speed control width WVl and an enlarged inter-vehicle distance control width WDl, respectively. As a result, the lower limit vehicle speed Vmin and the upper limit inter-vehicle distance Dmax are set to a low vehicle speed Vl and a long inter-vehicle distance Dl, respectively.

On the other hand, when the driver operates the assistance level setting operation device 53 to set the driving assistance level l to the medium assistance level Lm, the vehicle driving assistance apparatus 10 sets the target vehicle speed control width WVtgt and the target inter-vehicle distance control width WDtgt to a standard vehicle speed control width WVb and a standard inter-vehicle distance control width WDb, respectively. As a result, the lower limit vehicle speed Vmin and the upper limit inter-vehicle distance Dmax are set to a standard vehicle speed Vb and a standard inter-vehicle distance Db, respectively.

Further, when the driver operates the assistance level setting operation device 53 to set the driving assistance level L to the weak assistance level Lw, the vehicle driving assistance apparatus 10 sets the target vehicle speed control width WVtgt and the target inter-vehicle distance control width WDtgt to a reduced vehicle speed control width WVs and a reduced inter-vehicle distance control width WDs, respectively. As a result, the lower limit vehicle speed Vmin and the upper limit inter-vehicle distance Dmax are set to a high vehicle speed Vh and a short inter-vehicle distance Ds, respectively.

Here, the low vehicle speed Vl is lower than the standard vehicle speed Vb. Further, the high vehicle speed Vh is higher than the standard vehicle speed Vb. Furthermore, the long inter-vehicle distance Dl is longer than the standard inter-vehicle distance Db. Furthermore, the short inter-vehicle distance Ds is shorter than the standard inter-vehicle distance Db.

Thus, when the driving assistance level L is set to a first level (in this example, the weak assistance level Lw), the vehicle driving assistance apparatus 10 sets a predetermined vehicle speed range (that is, the target vehicle speed range RVtgt) and a predetermined distance range (that is, the target inter-vehicle distance range RDtgt) to narrow ranges as compared with when the driving assistance level L is set to a second level higher than the first level (in this example, the medium assistance level Lm or the strong assistance level Ls).

At a predetermined timing, the vehicle driving assistance apparatus 10 starts a process from a step S300 of the routine shown in FIG. 3. Then, the vehicle driving assistance apparatus 10 proceeds with the process to a step S305 to determine whether or not a driving assistance request condition C1 is satisfied. The driving assistance request condition C1 is satisfied when execution of the driving assistance control is requested. On the other hand, the driving assistance request condition C1 is not satisfied when stopping of the driving assistance control is requested.

When the driving assistance request condition C1 is not satisfied, the vehicle driving assistance apparatus 10 determines “No” at the step S305, and proceeds with the process directly to a step S395 to terminate the process of this routine once. On the other hand, when the driving assistance request condition C1 is satisfied, the vehicle driving assistance apparatus 10 determines “Yes” at the step S305, and proceeds with the process to a step S310 to determine whether or not an intermittent travel request condition C2 is satisfied. The intermittent travel request condition C2 is satisfied when execution of the intermittent travel control is requested. On the other hand, the intermittent travel request condition C2 is not satisfied when stopping of the intermittent travel control is requested.

When the intermittent travel request condition C2 is not satisfied, the vehicle driving assistance apparatus 10 determines “No” at the step S310, and proceeds with the process to a step S340 to execute the constant travel control. Subsequently, the vehicle driving assistance apparatus 10 proceeds with the process to the step S395 to terminate the process of this routine once.

On the other hand, when the intermittent travel request condition C2 is satisfied, the vehicle driving assistance apparatus 10 determines “Yes” at the step S310, and proceeds with the process to a step S315 to determine whether or not a preceding vehicle condition C3 is satisfied. The preceding vehicle condition C3 is satisfied when the preceding vehicle 200 exists.

When the preceding vehicle condition C3 is satisfied, the vehicle driving assistance apparatus 10 determines “Yes” at the step S315, and proceeds with the process to a step S320 to determine whether or not a prohibition condition C4 is satisfied. The prohibition condition C4 is satisfied when the driving assistance level L is set to the weak assistance level Lw.

When the prohibition condition C4 is not satisfied, the vehicle driving assistance apparatus 10 determines “No” at the step S320, and proceeds with the process to a step S330 to execute the intermittent inter-vehicle distance control. Subsequently, the vehicle driving assistance apparatus 10 proceeds with the process to the step S395 to terminate the process of this routine once.

On the other hand, when the prohibition condition C4 is satisfied, the vehicle driving assistance apparatus 10 determines “Yes” at the step S320, and proceeds with the process to a step S325 to execute the constant travel control. That is, when execution of the intermittent inter-vehicle distance control is requested (that is, when the intermittent inter-vehicle distance control is not executed), the vehicle driving assistance apparatus 10 executes the constant travel control without executing the intermittent inter-vehicle distance control. That is, in this case, execution of the intermittent inter-vehicle distance control is prohibited. On the other hand, when the vehicle driving assistance apparatus 10 is executing the intermittent inter-vehicle distance control, the vehicle driving assistance apparatus 10 stops the intermittent inter-vehicle distance control and executes the constant travel control. That is, also in this case, execution of the intermittent inter-vehicle distance control is prohibited. Then, in these cases, since the preceding vehicle 200 exists, the vehicle driving assistance apparatus 10 executes the constant inter-vehicle distance control as the constant travel control. Subsequently, the vehicle driving assistance apparatus 10 proceeds with the process to the step S395 to terminate the process of this routine once.

Thus, when the driving assistance level L is set to a predetermined level or less (in this example, when the driving assistance level L is set to the weak assistance level Lw) when execution of the intermittent inter-vehicle distance control is requested, the vehicle driving assistance apparatus 10 does not execute the intermittent inter-vehicle distance control. Further, when the driving assistance level L is set to the predetermined level or less (in this example, when the driving assistance level L is set to the weak assistance level Lw) when the vehicle driving assistance apparatus 10 is executing the intermittent inter-vehicle distance control, the vehicle driving assistance apparatus 10 stops the intermittent inter-vehicle distance control.

In particular, when the driving assistance level is set to a predetermined level or less (in this example, when the driving assistance level L is set to the weak assistance level Lw) when execution of the intermittent inter-vehicle distance control is requested, the vehicle driving assistance apparatus 10 executes the constant inter-vehicle distance control as the driving assistance control without executing the intermittent inter-vehicle distance control, and when the driving assistance level is set to the predetermined level or less (in this example, when the driving assistance level L is set to the weak assistance level Lw) when the intermittent inter-vehicle distance control is being executed, the vehicle driving assistance apparatus 10 stops the intermittent inter-vehicle distance control and executes the constant inter-vehicle distance control as the driving assistance control.

Further, when the preceding vehicle condition C3 is not satisfied at a time when the vehicle driving assistance apparatus 10 has proceeded with the process to the step S315, the vehicle driving assistance apparatus 10 determines “No” at the step S315, and proceeds with the process to a step S335 to execute the intermittent vehicle speed control. Subsequently, the vehicle driving assistance apparatus 10 proceeds with the process to the step S395 to terminate the process of this routine once.

The above is the operation of the vehicle driving assistance apparatus 10.

When the driver of the host vehicle 100 sets the driving assistance level L to a low level, the driver desires that the host vehicle speed V1 does not greatly change. However, during execution of the intermittent inter-vehicle distance control, depending on the travel speed of the preceding vehicle 200, the host vehicle speed V1 may greatly change. Therefore, even when the driver sets the driving assistance level L to a low level, when the intermittent inter-vehicle distance control is executed, the host vehicle speed V1 may greatly change.

According to the vehicle driving assistance apparatus 10, when the driving assistance level L is set to a first level (that is, the weak assistance level Lw) lower than a second level (that is, the medium assistance level Lm or the strong assistance level Ls), the intermittent inter-vehicle distance control is not executed. Therefore, when the driver desires that the host vehicle speed V1 does not greatly change, it is possible to suppress the host vehicle speed V1 from greatly changing. Thus, it is possible to execute the driving assistance control at the driving assistance level L in accordance with an intention of the driver.

It should be noted that the present invention is not limited to the above-described embodiment, and various modified examples can be adopted within a scope of the present invention.

What is claimed is:

1. A vehicle driving assistance apparatus including an electronic control unit that executes an intermittent travel control of autonomously driving a host vehicle as a driving assistance control,
the intermittent travel control including an intermittent vehicle speed control and an intermittent inter-vehicle distance control,
the intermittent vehicle speed control being a control of driving the host vehicle by autonomously and alternately repeating a powering control of causing the host vehicle to travel by a driving force and a coasting control of causing the host vehicle to coast such that a travel speed of the host vehicle is maintained within a predetermined vehicle speed range when a preceding vehicle does not exist,
the intermittent inter-vehicle distance control being a control of driving the host vehicle by autonomously and alternately repeating the powering control and the coasting control such that an inter-vehicle distance between the host vehicle and the preceding vehicle is maintained within a predetermined distance range when the preceding vehicle exists,
a driving assistance level for the host vehicle by the intermittent travel control being set by an operator of the host vehicle,
wherein the electronic control unit is configured to:
when the driving assistance level is set to a first level, set the predetermined vehicle speed range and the predetermined distance range to narrower ranges as compared with when the driving assistance level is set to a second level higher than the first level; and
not execute the intermittent inter-vehicle distance control when execution of the intermittent inter-vehicle distance control is requested and the driving assistance level is set to a predetermined level or less.

2. The vehicle driving assistance apparatus according to claim 1,
wherein the electronic control unit is configured to:
not execute the intermittent inter-vehicle distance control when execution of the intermittent inter-vehicle distance control is requested and the driving assistance level is set to the predetermined level or less; and
stop the intermittent inter-vehicle distance control when the driving assistance level is set to the predetermined level or less while the intermittent inter-vehicle distance control is executed.

3. The vehicle driving assistance apparatus according to claim 1,
wherein the electronic control unit is configured to:
execute a constant inter-vehicle distance control as the driving assistance control without executing the intermittent inter-vehicle distance control when execution of the intermittent inter-vehicle distance control is requested and the driving assistance level is set to the predetermined level or less; and
stop the intermittent inter-vehicle distance control and execute the constant inter-vehicle distance control as the driving assistance control when the driving assistance level is set to the predetermined level or less while the intermittent inter-vehicle distance control is being executed, and
the constant inter-vehicle distance control is a control of driving the host vehicle by autonomously performing acceleration and deceleration of the host vehicle such that the inter-vehicle distance is maintained at a predetermined inter-vehicle distance when the preceding vehicle exists.

4. A vehicle driving assistance method for executing an intermittent travel control of autonomously driving a host vehicle as a driving assistance control,
the intermittent travel control including an intermittent vehicle speed control and an intermittent inter-vehicle distance control,
the intermittent vehicle speed control being a control of driving the host vehicle by autonomously and alternately repeating a powering control of causing the host vehicle to travel by a driving force and a coasting control of causing the host vehicle to coast such that a travel speed of the host vehicle is maintained within a predetermined vehicle speed range when a preceding vehicle does not exist,
the intermittent inter-vehicle distance control being a control of driving the host vehicle by autonomously and alternately repeating the powering control and the coasting control such that an inter-vehicle distance between the host vehicle and the preceding vehicle is maintained within a predetermined distance range when the preceding vehicle exists,
a driving assistance level for the host vehicle by the intermittent travel control being set by an operator of the host vehicle,
wherein the vehicle driving assistance method comprises steps of:
when the driving assistance level is set to a first level, setting the predetermined vehicle speed range and the predetermined distance range to narrower ranges as compared with when the driving assistance level is set to a second level higher than the first level; and
not executing the intermittent inter-vehicle distance control when execution of the intermittent inter-vehicle distance control is requested and the driving assistance level is set to a predetermined level or less.

5. A computer-readable non-transitory storage medium storing a vehicle driving assistance program that executes an intermittent travel control of autonomously traveling a host vehicle as a driving assistance control,
the intermittent travel control including an intermittent vehicle speed control and an intermittent inter-vehicle distance control,
the intermittent vehicle speed control being a control of driving the host vehicle by autonomously and alternately repeating a powering control of causing the host vehicle to travel by a driving force and a coasting control of causing the host vehicle to coast such that a travel speed of the host vehicle is maintained within a predetermined vehicle speed range when a preceding vehicle does not exist,
the intermittent inter-vehicle distance control being a control of driving the host vehicle by autonomously and alternately repeating the powering control and the coasting control such that an inter-vehicle distance between the host vehicle and the preceding vehicle is maintained within a predetermined distance range when the preceding vehicle exists,
a driving assistance level for the host vehicle by the intermittent travel control being set by an operator of the host vehicle,
wherein the vehicle driving assistance program is configured to:
when the driving assistance level is set to a first level, set the predetermined vehicle speed range and the predetermined distance range to narrower ranges as compared with when the driving assistance level is set to a second level higher than the first level; and
not execute the intermittent inter-vehicle distance control when execution of the intermittent inter-vehicle distance control is requested and the driving assistance level is set to a predetermined level or less.
